(19) United States
(12) Patent Application Publication
(10) Pub. No.: US 2002/0088498 A1
(43) Pub. Date: Jul. 11, 2002

(54) Portable air tank booster

(76) Inventor: Mitchell G. House, McComb, MS (US)

Correspondence Address: Mitchell G. House, 1161 Chester Reeves Rd., McComb, MS, 39648, US

(21) Appl. No.: 09/994,884

(22) Filed: Nov. 28, 2001

Related U.S. Application Data
(60) Provisional application No. 60/231,865, filed on Sep. 12, 2000.

(51) Int. Cl. F16K 11/076; G05D 16/00

(52) U.S. Cl. 137/565.18; 137/625.47

(57) ABSTRACT

A portable air tank 30 that adapts from a ⅜ inch air supply line 17 to a 1 inch delivery line 15 and 18 and powers a one inch heavy duty extended anvil impact wrench 23 with a continuous supply of air power 110 to 120 psi. The air wind throw is reduced from 150 feet to 15 feet 18. The tank is portable and easily adapted to various air compressors.

### CROSS-REFERENCE TO RELATED APPLICATIONS

Not applicable

### BACKGROUND

### FIELD OF INVENTION

This invention relates to air compression that powers the 1″ heavy-duty extended anvil impact wrench, specifically to adapting a portable air tank that boost the pressure per square inch (PSI).

### DESCRIPTION OF PRIOR ART

Manufacturing and repair shops use 1″ heavy-duty impact wrenches for removing wheels and other jobs. These wrenches are powered by large air compressors that have long hoses leading to various work stations throughout the shop.

Originally these one inch air hoses had to be dragged around to take off wheels from trailers and trucks. The length of the hose maybe 150 feet or more.

Thus due to the length of the hose, the psi would soon drop from 120 to about 90 psi. This caused the workers to wait for the compressor to build back up again. Dragging this long hose and waiting for pressure build-up made working conditions tiresome and time consuming for the shopworkers.

### SUMMARY

In accordance with the present invention, a portable air tank booster comprises a 6.5 gallon air tank with a ⅜″ rubber air hose connector on one end and one inch adapter on the other end which attaches 15 feet of one inch air hose to the tank and leads to an anvil impact wrench.

### OBJECTS AND ADVANTAGES

Accordingly, several objects and advantages of the present invention are;

(a) to provide a continuous supply of air power;

(b) to provide easy hook-up to air couplers in the air supply system;

(c) to provide easy monitoring of air pressure;

(d) to provide emergency road use to large trucks by adapting to their air tank reservoir;

(e) to provide easy storage of air hoses;

(f) to provide a stronger air pressure for 1″ impact wrench;

(g) to provide less weight and easier portability for impact wrench operation;

(h) to provide reduced length of air wind throw from 150 feet to 15 feet;

(i) to provide a “buildup” of air pressure near the heavy duty extended anvil impact wrench; and

(j) to provide a smaller and cheaper air compressor that gives a larger volume of air to power the heavy duty one inch extended anvil impact wrench.

Further objects and advantages are to provide a ⅜″ air hose and a smaller, less expensive compressor that delivers a shorter air wind throw, and adjusts from a ⅜″ air hose to 1″ air hose which delivers a continuous wind throw of 110 to 120 psi power to the 1″ extended anvil impact wrench by allowing air pressure “build-up” near the impact wrench operation. Still further objects and advantages will become apparent from a consideration of the ensuing description and drawings.

### DRAWING FIGURES

In the drawings, closely related figures have the same number but different alphabetic suffixes.

FIGS. 1A to 1C show various sides of a 6.5 gallon air tank that measures 12½ inches high by 27 inches long and has a circumference of 38½ inches. FIG. 1A is the bottom of the tank; FIG. 1B is the side of the tank; and FIG. 1C is the top of the tank.

FIG. 2 shows welded metal feet with rubber tip rests attached to the bottom of the tank.

FIG. 3 shows welded metal handles with a cord wrap hook which is attached to the ends of the tank.

FIG. 4 shows the welded metal handle attached to the top of the tank.

FIG. 5A shows the ⅜ inch male coupler which screws into the top of the tank. FIG. 5B shows the air pressure gauge that screws into the top of the tank.

FIG. 6A to 6D shows a one inch adapter in the tank; a 1 inch rubber air hose; a ¾ inch adapter that attaches to the ¾ inch plug for an impact wrench.

FIG. 7 shows an air tank being used in a large shop with many ⅜ inch air line wire roots.

FIG. 8A to 8E shows an air tank hooked to an eighteen wheeler truck's air compressor/reservoir.

FIG. 9 shows an eighteen wheeler and a booster air tank attached to an impact wrench.

FIG. 10 shows a booster air tank attached to a small electric 5.5 H.P., 30 gallon air compressor that produces 125 psi, maximum power.

FIG. 11 shows a booster air tank attached to a 5 H.P., 20 gallon gasoline compressor that produces 145 psi maximum power.

### REFERENCE NUMERALS IN DRAWINGS

| | |
|---|---|
| 12 | resting feet |
| 13 | cord wrap hooks |
| 14 | carrying handle |
| 15 | 1 inch female coupler |
| 16 | air pressure gauge |
| 17 | 3/8 inch male coupler |
| 18 | fifteen feet of one inch rubber air hose |
| 19 | 3/4 inch adapter |
| 20 | 3/4 inch plug for impact wrench |
| 21 | shop air compressor |
| 22 | 3/8 inch air line wire root |
| 23 | one inch heavy duty extended anvil impact wrench |
| 24 | large truck air compressor |
| 25 | large truck air reservoir tank |
| 26 | “½ inch ‘t’” place in air brake line |
| 27 | large trick air brake line |
| 28 | shut-off valve for air line “½ inch” |
| 29 | 3/8 inch adapter to attach air line wire root |
| 30 | 6.5 gallon portable air tank booster |
| 31 | electric air compressor |
| 32 | gasoline air compressor |

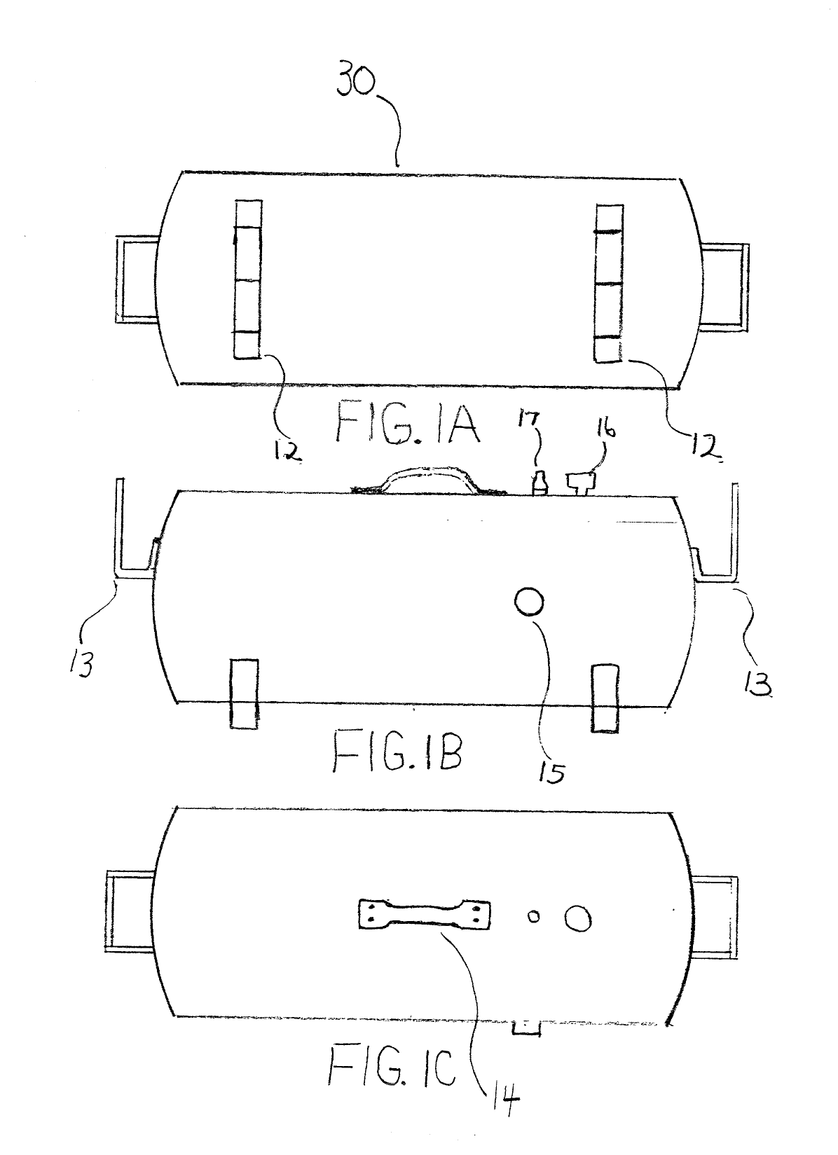

### DESCRIPTION—FIGS. 1A to 1C—Preferred Embodiment

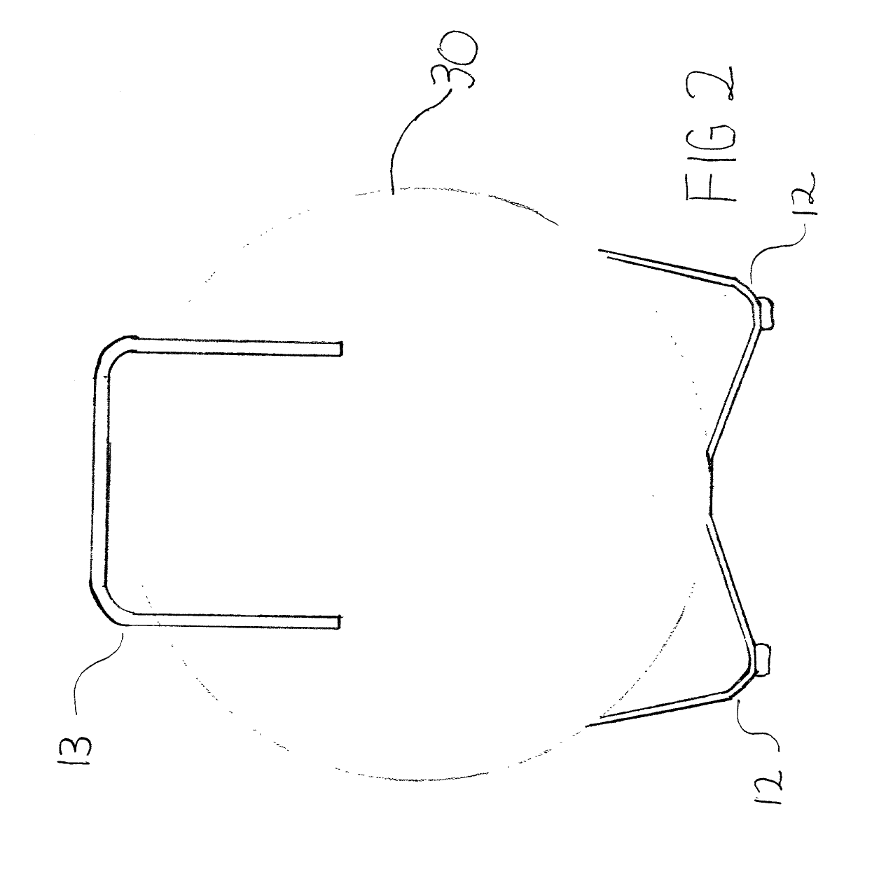

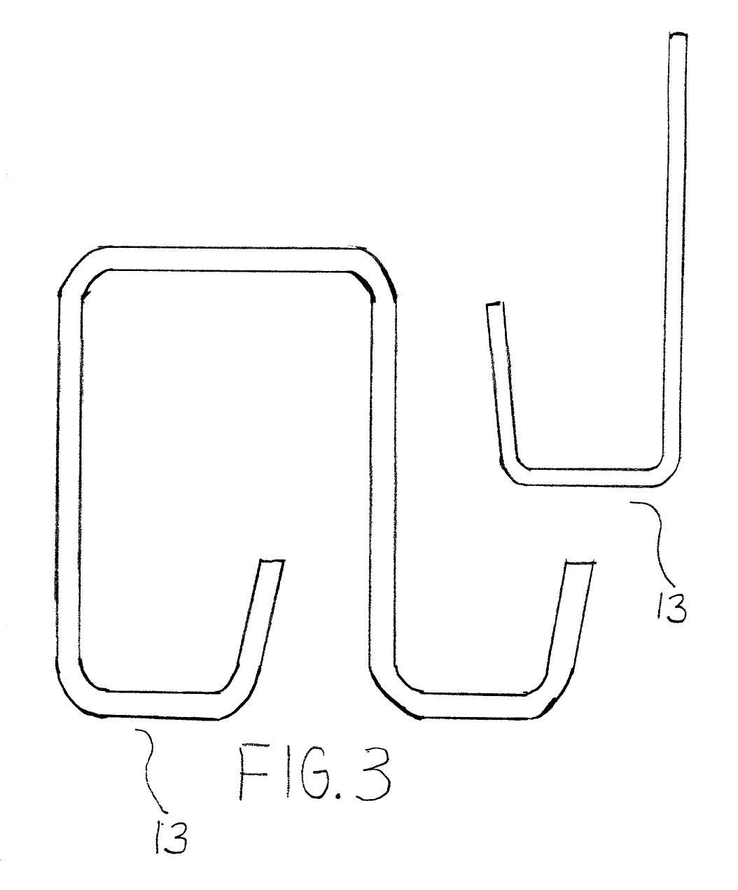

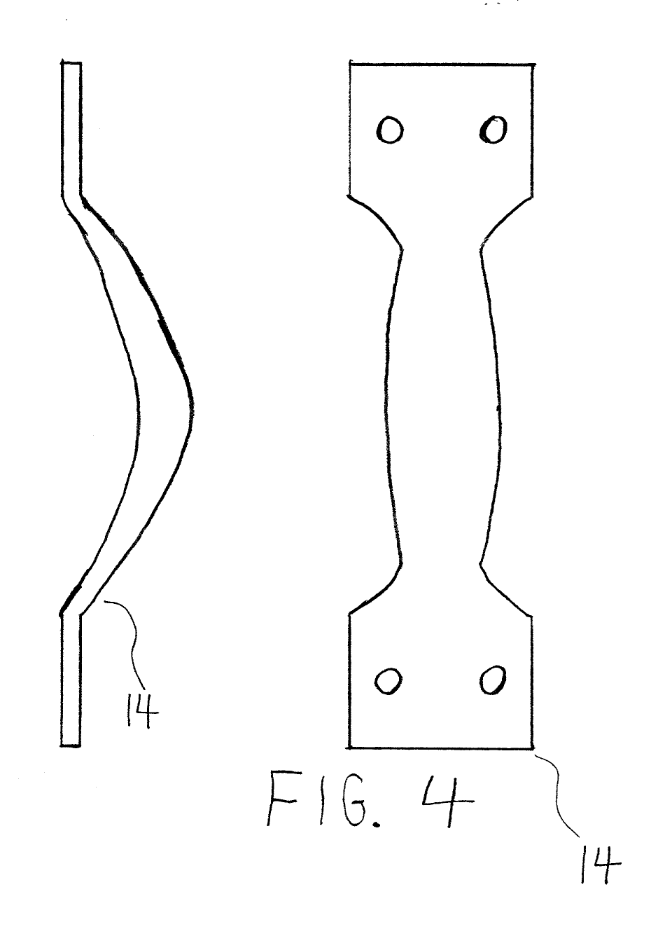

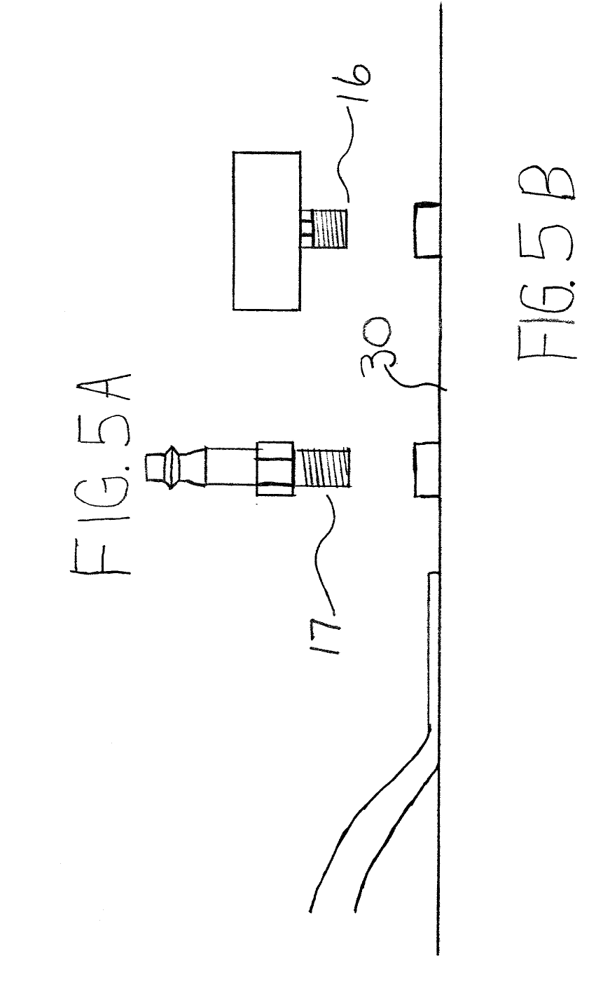

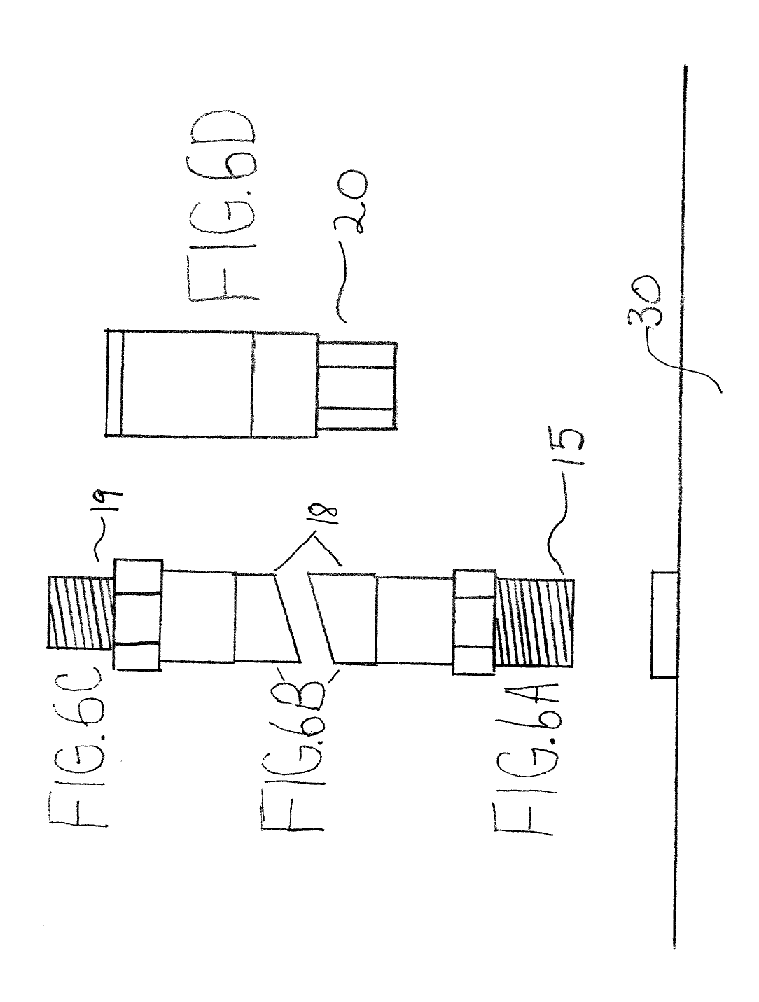

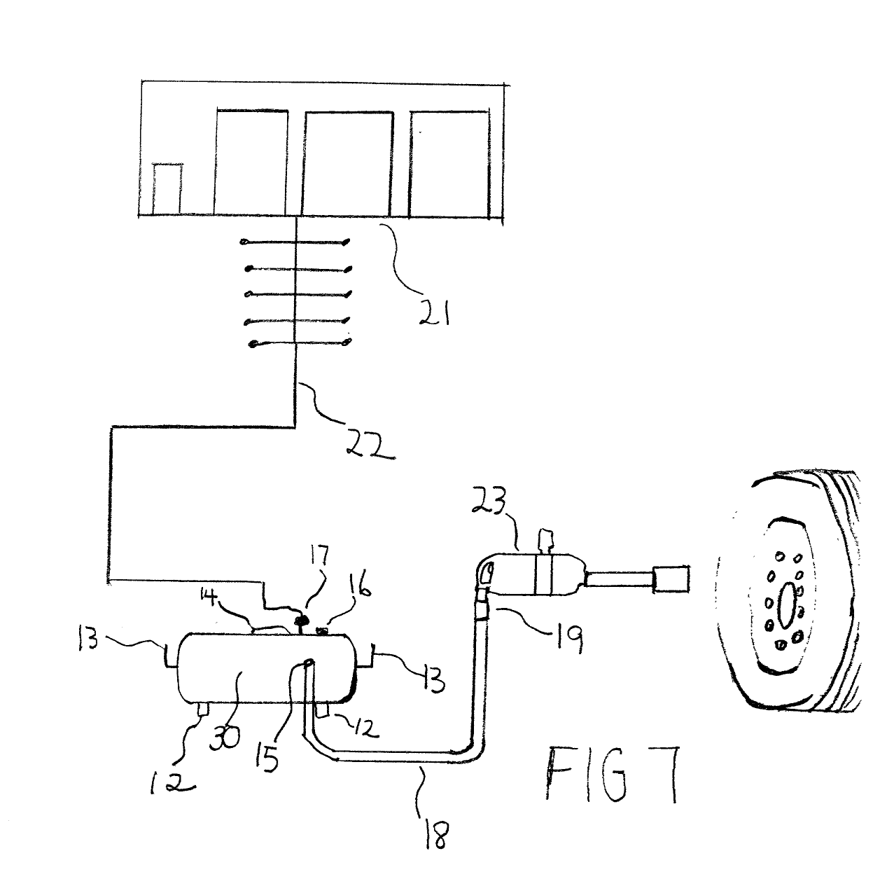

A preferred embodiment of the present invention is illustrated in FIG. 1B ; FIG. 5A; FIG. 6A to 6D; and FIG. 7. The portable air tank booster is 12.5 inches in diameter and 38.5 inches long (FIG. 1B and FIG. 2). The tank is made of heavy metal that can be cut and welded. The top handle 14 (FIG. 4) and the side hooks 13 (FIG. 3) are made of ⅜ inch diameter pipe. These are bent to shape and welded into place. The handles/hooks on the ends of the tank serve as a rap around for the 15 feet, one inch air hose connected to the booster tank.

The tank rests on feet 12 (FIG. 2) made from 1/16 inch thick by 2½ inches wide and 20 inches long. These feet are welded in place. Air pressure in the tank is monitored by a pressure gauge 16 (FIG. 5B). This gauge is screwed into the tank.

The tank receives its air supply through a ⅜ inch male coupling 17 (FIG. 5A) threaded into the top of the booster tank 30. The delivery end of the tank 30 is a female coupling threaded into the tank one inch in diameter 15 (FIG. 6A). Fifteen feet of rubber air hose one inch in diameter 18 (FIG. 6B) is attached to the booster tank. A ¾ inch adapter is located on the end of the one inch, fifteen foot cord 19 (FIG. 6C) to allow for a ¾ inch plug 20 (FIG. 6D) that attaches a one inch heavy duty extended anvil impact wrench 23 (FIG. 7).

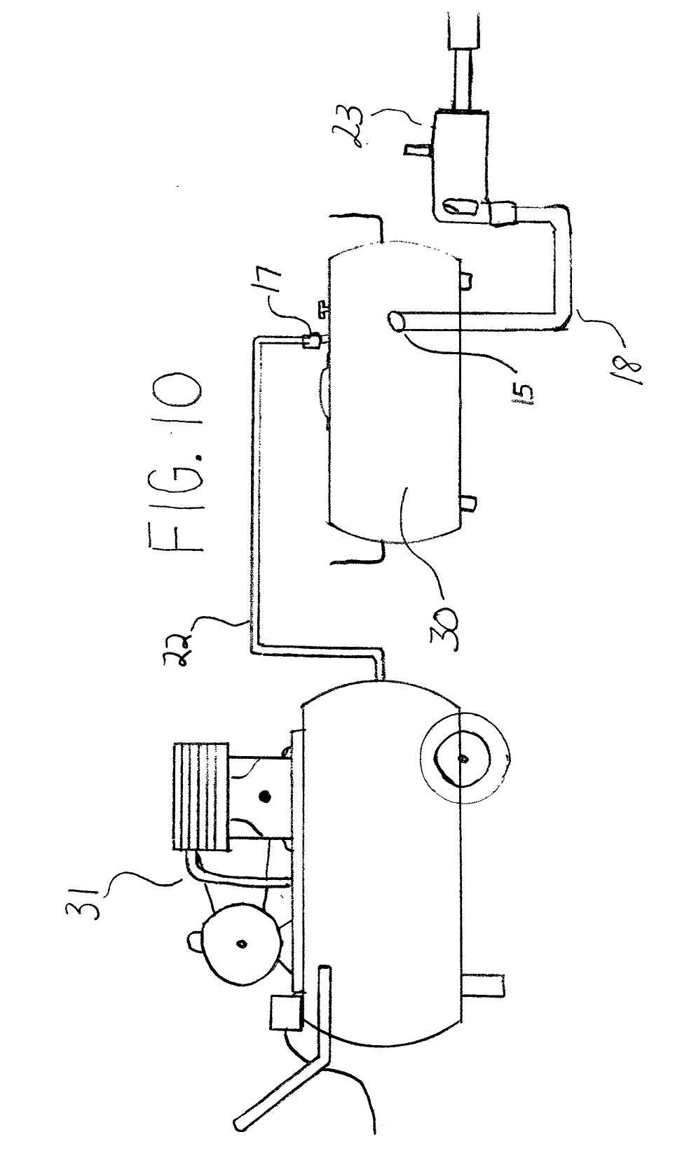

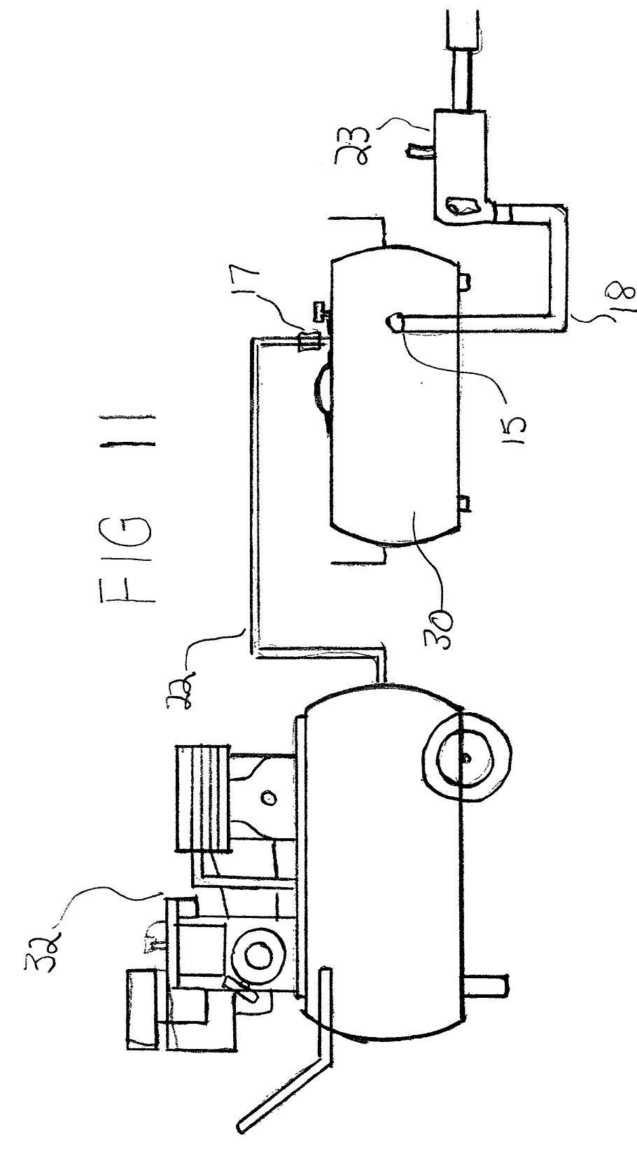

FIGS. 10-11: Additional Embodiments

Additional embodiments are shown in FIGS. 10 and 11; in each case the invention is shown powered by a smaller compressor and supply line 32,31 (FIG. 10 is an electric compressor and FIG. 11 is a gasoline compressor).

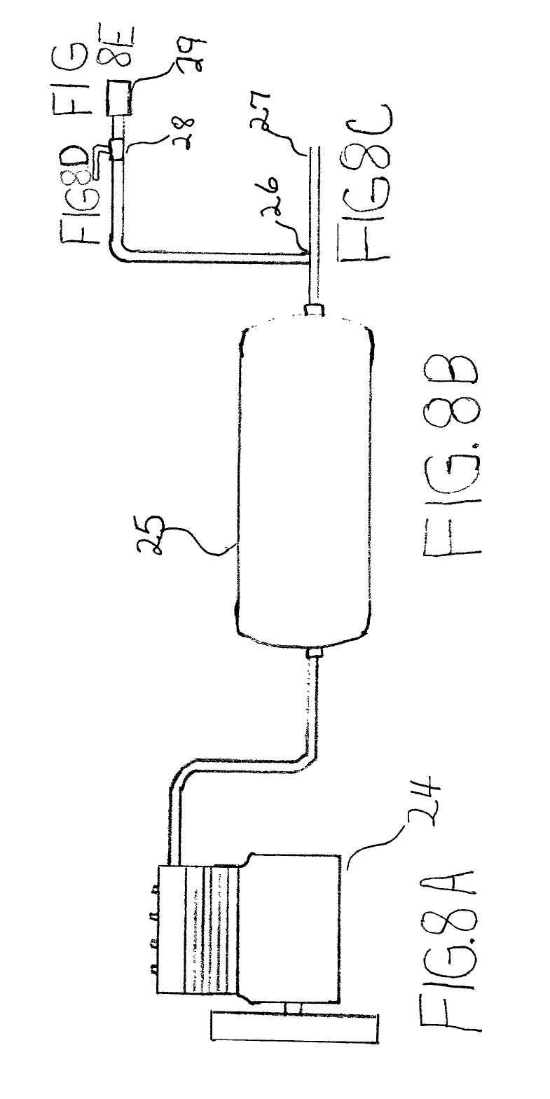

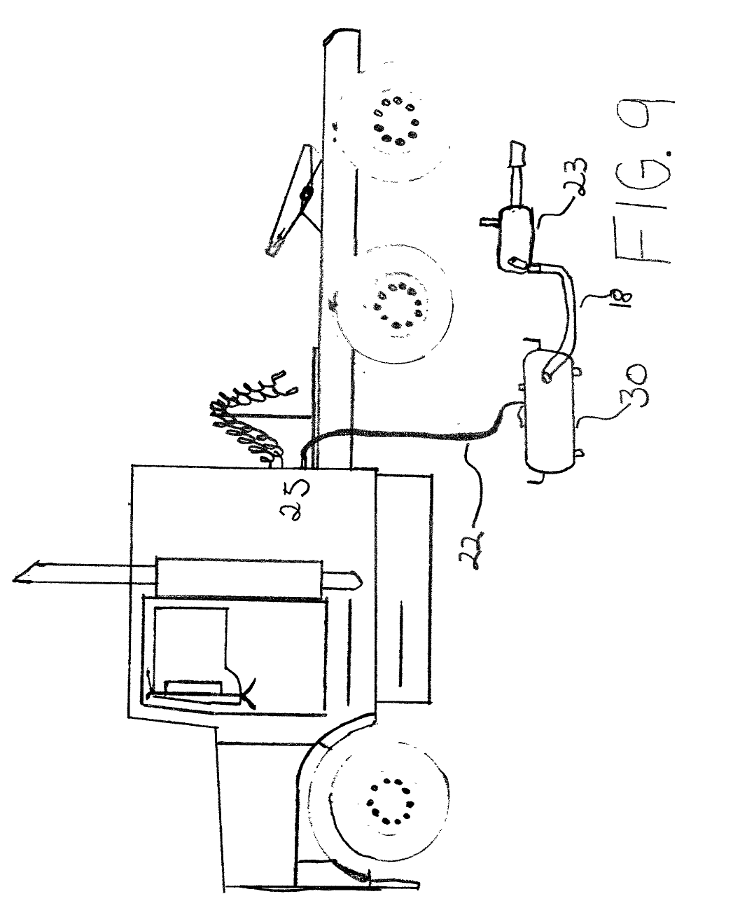

FIGS. 8A-8E and FIG. 9—Alternative Embodiments

There are various possibilities with regard to the portable booster. FIG. 9 shows a truck reservoir powering the portable air tank booster tank 25 (FIG. 9).

Large trucks air brake reservoir tank 25 (FIG. 8B) has a line leading to the air brakes 27 (FIG. 8C). Install a ½ inch “t” 26 (FIG. 8C) and divert the air to the air booster tank through a ⅜ inch adapter 29 (FIG. 8E).

Advantages

From the description above, a number of advantages of my portable air tank booster become evident:

(a) The air impact worker does not have to drag around a long, heavy 1-inch air hose to each truck to take wheels off.

(b) The psi does not drop due to a shorter air wind throw.

(c) The booster tank provides a continuous supply of air power at 120 psi.

(d) The specially designed handle allows the tank to be easily transported.

(e) Truck drivers can adapt a coupler to their trucks air tank reservoir to run a line to the booster tank for emergency road use.

Operation—FIGS. 7 and 8A-8E

The manner of using the portable air tank booster is best described in FIGS. 7 and 8A-8E. In large truck repair shops, there are many ⅜ inch steel pipe air roots to power impact wrenches. This ⅜ inch air root attaches to a specially designed air tank of heavy metal about 6.5 gallon capacity 30 (FIG. 7).

The tank air gauge 16 (FIG. 7 ) monitors air pressure from 0-160. A one inch air hose is attached to the side of the air booster tank and plugs into the one inch extended anvil impact wrench 23 (FIG. 7) to deliver 120 psi. The air wind throw is reduced from 150 feet to 15 feet, thus giving a steady and greater force due to the build-up of air pressure in the portable air tank boosters.

Conclusion, Ramifications, and Scope

Accordingly, the reader will see that the portable air tank booster can be used to reduce work time, and save expense for tool makers, shop workers/owners, and truck drivers. Furthermore, the portable air booster tank has the additional advantages in that

it permits shop owners to accommodate a one inch air hose using a smaller compressor and supply line;

hook handles allow the 15 feet air hose to be wrapped around the portable tank for easy transporting;

it has a handle on top for easy transporting;

it delivers a greater psi (120 vs 90 psi);

it speeds up work time;

it reduces weight for the impact wrench operator to drag behind the wrench;

it reduces shutdown time for truck drivers that breakdown on the road.

Although the description above contains many specificities, these should not be construed as limiting the scope of the invention but as merely providing illustrations of some of the presently preferred embodiments of this invention. For example, the portable air tank booster can have other sizes and shapes; other colors; other adapters to power larger impact wrenches; home, shop, or truck use, etc.

Thus the scope of the invention should be determined by the appended claim and its legal equivalents, rather than by the examples given.

I claim:

1. A booster air reservoir tank comprising:
a. a tank of sufficient size to accommodate a substantial air pressure,
b. said tank having a plurality of adaptors, and
c. means for joining said tank at said adaptors providing access to air pressure reservoir,
whereby an air impact wrench power can be continuously maximized.
